(19) United States
(12) Patent Application Publication
(10) Pub. No.: US 2021/0248854 A1
(43) Pub. Date: Aug. 12, 2021

(54) System for Organizing Candidate Data

(71) Applicant: Oliver Brown, Jacksonville, FL (US)

(72) Inventor: Oliver Brown, Jacksonville, FL (US)

(21) Appl. No.: 17/173,288

(22) Filed: Feb. 11, 2021

Related U.S. Application Data
(60) Provisional application No. 62/975,225, filed on Feb. 12, 2020.

(51) Int. Cl. G07C 13/00; G06F 16/9535; G06F 16/9536; G06F 16/9538; G06F 21/62; H04L 29/06; G06Q 30/02; G06Q 50/26

(52) U.S. Cl. CPC G07C 13/00; G06F 16/9535; G06F 16/9536; G06F 16/9538; G06Q 2230/00; H04L 63/104; G06Q 30/0279; G06Q 50/26; G06F 21/6227

(57) ABSTRACT

The present disclosure provides generally for a system for organizing candidate data. More specifically, the present disclosure relates to a universal platform may streamline the interplay between each party, from voters, parties, individuals, local organizing bodies, and government. The interface may utilize information from a unique database to support the uploading of different data sources. The platform may be accessed through an external website and provide local voters the opportunity to get more information, donate to, or get involved with relevant candidates. Generally, the platform may allow managing groups to present their voters with a one stop location to view and donate to candidates in a single location. The platform may allow voters to view and donate to both candidates and managing groups, allowing for the collection of voter information and donor information for candidate donations.

### CROSS REFERENCE TO RELATED APPLICATION

This application claims priority to and the full benefit of U.S. Provisional Patent Application Ser. No. 62/975,225, filed Feb. 12, 2020, and titled “SYSTEM FOR ORGANIZING CANDIDATE DATA”, the entire contents of which are incorporated in this application by reference.

### BACKGROUND OF THE DISCLOSURE

Historically, election information was disseminated through campaigning and media. Traditional campaigning occurred either directly through a person running for a position or from volunteers advocating on behalf of someone else. Grassroots movements were important in the beginning of campaigning, where word of mouth and support from a community could go a long way to supporting a nominee.

Newspapers and news outlets discussed elections and positions, but the voter was significantly dependent on the campaigning of candidates. As of 2020, there were 3,006 counties, 64 parishes, 19 organized boroughs, 11 census areas, 41 independent cities, and the District of Columbia for a total of 3,142 counties and county-equivalents in the United States. Additionally, there are 16,800 public schools districts in the United States that have elected officials in local elections. The quantity of elections, candidates, and voters grow each year.

Organized parties or people interested in running still lack a centralized base for information about who could be running in their community, whether it be for something like a parent-teacher association or who is running for state or federal political offices. Organized parties or individuals themselves may want to control their messaging while still having access to their local resources, like having a county provide information on when local primaries or elections may be held.

When a voter arrives at a polling or voting station, there is still confusion over who is the person appearing on a ballot. Some voters may want to research or know more about their local candidates before they cast a vote. Others may want to contribute financially or volunteer directly with a candidate's campaign. Still others may want to see what a candidate's platform is, and whether they have been active in the news or social media to learn more about their goals. Each time, the voter or participant may have to go to a different place or resource to be able to achieve their goal, whatever it may be.

### SUMMARY OF THE DISCLOSURE

What is needed is a universal platform that may provide voters with election information, whether it be at the local, state, or federal level. This universal platform may allow groups and candidates to track and manage voter information. Each side can discover more information about the other in an organized, uniform fashion. A universal platform may streamline the interplay between each party, from voters, parties, individuals, local organizing bodies, and government. Accordingly, the present disclosure relates to a dynamic interface to support the custom business rules engine for each managing group. In some aspects, the interface may utilize information from a unique database to support the uploading of different data sources.

Generally, the platform may allow managing groups to present their voters with a one stop location to view and donate to candidates in a single location. In some embodiments, the platform may be accessed through an external web-site and provide local voters the opportunity to get more information, donate to, or get involved with relevant candidates. In some aspects, the platform may allow voters to view and donate to both candidates and managing groups, facilitating the collection of voter information and donor information for candidate donations. The platform may provide an opportunity for candidates to manage their own content.

The summary of candidate page may be hosted by the platform and may allow voters to see all organizational candidates in the races in their area. The page may identify political races and each candidate in each race. Voters may select a candidate listing for additional information. In some aspects, a candidate listing page may provide a searchable function by street address, which may allow a voter to view relevant candidates.

In some embodiments, the database may be based on information collected from a range of disparate sources. In some aspects, the information may be standardized from the different sources, wherein the data may be processed and accessed in a uniform manner, which may allow for a streamlined interface that may present the information in a user-friendly format. In some implementations, an organizing entity may determine whether a candidate appears to a voter. For example, a candidate that does not make it through the primary may not appear during a general election cycle.

The present disclosure relates to a method for generating a candidate page. In some embodiments, the method may comprise: receiving candidate data for a first candidate, where the candidate data may comprise: a name, a first election, a first managing group membership, where the first managing group membership indicates an association of the first candidate with a first managing group, a first position, and first position data; identifying the first election within the managing group; identifying a first candidate page display structure associated with the first election based on the first managing group; generating a first candidate page based on the first candidate page display structure; and populating the first candidate page with the name and the first position data. Embodiments of this aspect include corresponding computer systems, apparatus, and computer programs recorded on one or more computer storage devices, each configured to perform the actions of the methods.

Implementations may include one or more of the following features. In some aspect, the candidate page may be accessible to members of the first management group. The method may include identifying the first managing group membership for the first candidate. The first candidate page may be at least partially customizable by the candidate.

At least a portion of the first position data may be received from the external third party database. The method may comprise: receiving a first access request through a server for a first viewer to view the first candidate page; confirming a first viewer membership to the first managing group; and providing the first candidate page to the first viewer if the first viewer membership exists. The first candidate page may be at least partially customizable by the first viewer.

The candidate data further may comprise: a second election; a second managing group membership, where the second managing group membership indicates an association of the first candidate with a second managing group; a second position; and second position data. The method may include: identifying the second election within the second managing group; identifying a second candidate page display structure associated with the first election based on the second managing group; generating a second candidate page based on the second candidate page display structure; and populating the second candidate page with the name and the second position data.

The candidate data further may comprise: a second managing group membership, where the second managing group membership indicates an association of the first candidate with a second managing group. The method may include: identifying a second candidate page display structure associated with the first election based on the second managing group; generating a second candidate page based on the second candidate page display structure; and populating the second candidate page with the name and the first position data.

The second candidate page may be a default page display for the first candidate. The method may include: receiving a first access request through a server for a first viewer to view the first candidate page; confirming a first viewer membership to the first managing group; and providing the second candidate page to the first viewer if the first viewer membership does not exist. Implementations of the described techniques may include hardware, a method or process, or computer software on a computer-accessible medium.

One general aspect includes a method for generating a candidate page receiving candidate data for a first candidate, where the candidate data may comprise: a name, a plurality of elections, a plurality of managing group memberships for a plurality of managing groups, where each of the plurality of managing group memberships indicate an association with at least one of the plurality of managing groups, a plurality of positions, and a plurality of sets of position data, where each set is associated with at least one of the plurality of positions; associating each of the plurality of elections with at least a portion of the plurality of managing groups; identifying a candidate page display structure for each of the plurality of elections based on associated managing groups; generating a plurality of candidate pages based on the candidate page display structure for each of the plurality of elections based on associated managing groups; and populating the plurality of candidate pages with at least a portion of the candidate data. Other embodiments of this aspect include corresponding computer systems, apparatus, and computer programs recorded on one or more computer storage devices, each configured to perform the actions of the methods.

Implementations may include one or more of the following features. The method may include: receiving a first access request through a server for a first viewer to view at least one of the plurality of candidate pages; receiving viewer management group data; comparing the viewer management group data to the plurality of managing groups, where comparing determines overlapping memberships; and providing at least one candidate page to the first viewer based on overlapping memberships. At least a portion of the plurality of sets of position data is received from the external third party database. Implementations of the described techniques may include hardware, a method or process, or computer software on a computer-accessible medium.

One general aspect includes a method for managing elections. The method may further may comprise identifying a plurality of elections; receiving a plurality of candidates, where each of the plurality of candidates are running for a position within at least one of the plurality of elections; generating a plurality of candidate page display structures, where each of the plurality of candidate page display structures are associated with each of the plurality of election; and providing the plurality of candidate page display structures, where providing allows for population and display of a plurality of candidate pages.

Implementations may include one or more of the following features. The method may include managing at least a portion of the plurality of candidate pages. Managing may comprise monitoring donations submitted through candidate pages. Managing further may comprise limiting donations for each of the plurality of candidates. Implementations of the described techniques may include hardware, a method or process, or computer software on a computer-accessible medium.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary candidate list graphical user interface (GUI), according to some embodiments of the present disclosure.

FIG. 2 illustrates an exemplary candidate list graphical user interface (GUI), according to some embodiments of the present disclosure.

FIG. 3 illustrates exemplary candidate listings, according to some embodiments of the present disclosure.

FIG. 4 illustrates exemplary managing group interface panels, according to some embodiments of the present disclosure.

FIG. 5 illustrates an exemplary managing group reporting graphical user interface (GUI), according to some embodiments of the present disclosure.

FIG. 6 illustrates an exemplary managing group upload graphical user interface (GUI), according to some embodiments of the present disclosure.

FIG. 7 illustrates an exemplary managing group ballot graphical user interface (GUI), according to some embodiments of the present disclosure.

FIG. 8 illustrates exemplary candidate interface panels, according to some embodiments of the present disclosure.

FIG. 9 illustrates an exemplary candidate reporting graphical user interface (GUI), according to some embodiments of the present disclosure.

FIG. 10 illustrates an exemplary candidate account graphical user interface (GUI), according to some embodiments of the present disclosure.

FIG. 11 illustrates an exemplary candidate page, according to some embodiments of the present disclosure.

FIG. 12 illustrates an exemplary candidate page, according to some embodiments of the present disclosure.

FIG. 13 illustrates an exemplary candidate page, according to some embodiments of the present disclosure.

FIG. 14 illustrates a plurality of exemplary candidate pages, according to some embodiments of the present disclosure.

FIG. 15 illustrates a plurality of exemplary candidate pages, according to some embodiments of the present disclosure.

FIG. 16 illustrates an exemplary voter donation graphical user interface (GUI), according to some embodiments of the present disclosure.

FIG. 17 illustrates an exemplary candidate management platform organization structure, according to some embodiments of the present disclosure.

FIG. 18A illustrates an exemplary candidate management platform organization structure, according to some embodiments of the present disclosure.

FIG. 18B illustrates an exemplary candidate management platform organization structure, according to some embodiments of the present disclosure.

FIG. 19 illustrates an exemplary candidate management platform organization structure, according to some embodiments of the present disclosure.

FIG. 20 illustrates an exemplary candidate management platform organization structure, according to some embodiments of the present disclosure.

FIG. 21 illustrates an exemplary candidate management platform organization structure, according to some embodiments of the present disclosure.

FIG. 22 illustrates an exemplary candidate management platform organization structure, according to some embodiments of the present disclosure.

FIG. 23 illustrates a block diagram of an exemplary apparatus that may be used to implement aspects of the present disclosure, wherein the exemplary apparatus may comprise a mobile device, according to some embodiments of the present disclosure.

FIG. 24 illustrates an exemplary processing and interface system, according to some embodiments of the present disclosure.

FIG. 25 illustrates an exemplary process flowchart for a candidate management platform, according to some embodiments of the present disclosure.

FIG. 26 illustrates an exemplary block diagram for a candidate management platform, according to some embodiments of the present disclosure.

### DETAILED DESCRIPTION

The present disclosure provides generally for a system for organizing candidate data. More specifically, the present disclosure relates to a universal platform may streamline the interplay between each party, from voters, parties, individuals, local organizing bodies, and government. According to the present disclosure, the interface may utilize information from a unique database to support the uploading of different data sources. In some embodiments, the platform may be accessed through an external web-site and provide local voters the opportunity to get more information, donate to, or get involved with relevant candidates.

Generally, the platform may allow managing groups to present their voters with a one stop location to view and donate to candidates in a single location. In some aspects, the platform may allow voters to view and donate to both candidates and managing groups, allowing for the collection of voter information and donor information for candidate donations. The platform may provide an opportunity for candidates to manage their own content.

The summary of candidates page may be hosted by the platform and may allow voters to see all organizational candidates in the races in their area. The page may identify political races and each candidate in each race. Voters may select a candidate listing for additional information. In some aspects, a candidate listing page may provide a searchable function by street address, which may allow a voter to view relevant candidates.

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### GLOSSARY

Election: as used herein refers to any process where candidates may be identified and voted for to fill a position within a group or governing body. In some aspects, candidates may comprise individuals running for a position within a group. In some embodiments, elections may determine a winning selection from a pool of options, wherein the options may be considered candidates. For example, an election may determine a favorite mascot or film to be shown during a movie night.
Position: as used herein refers to a role within a group or governing body that may be filled through an election.
Candidate: as used herein refers to an individual who is identified and eligible to be voted for a particular position during an election, including nominees or individuals who do not go through a traditional selection process.
Candidate Management Platform: as used herein refers to a system for organizing candidate data. In some embodiments, a candidate management platform may allow a managing group to track and monitor data related to one or more candidates, elections, voters, donations, and positions.
Managing Group: as used herein refers to an entity that may be authorized to manage candidate visibility on a candidate management platform.
Voter: as used herein refers to an individual eligible to participate and vote in an election.

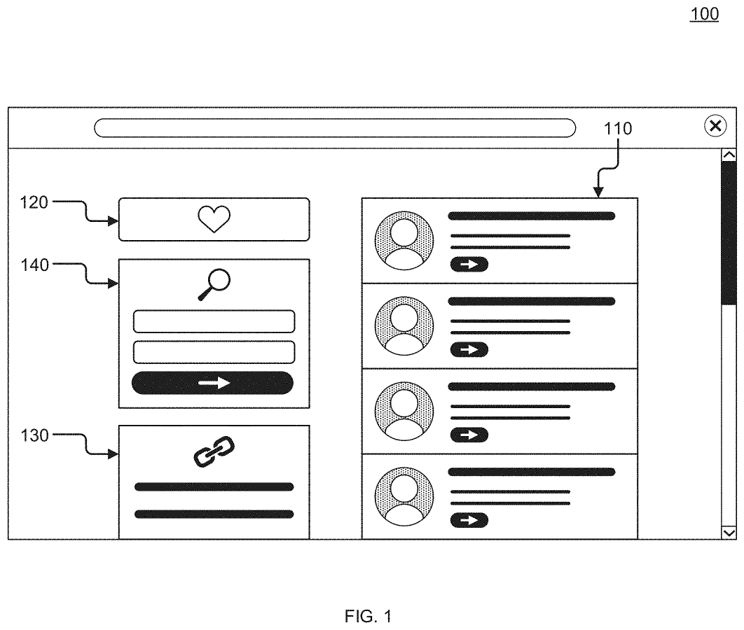

Referring now to FIG. 1, an exemplary candidate list graphical user interface (GUI) 100 is illustrated. In some implementations, the candidate list GUI 100 may comprise a candidate list 110, which may include candidates eligible for an active election. In some embodiments, the candidate list GUI 100 may comprise links to ballot lists 130 for active elections. In some embodiments, the candidate list GUI 100 may comprise a general support button 120, which may allow voters to directly contribute to a managing party. In some aspects, a general support button 120 may allow voters to volunteer for a managing party.

In some implementations, a default candidate list 110 may comprise basic information about each candidate, such as name and position. Candidates may be able to claim their profile and integrate their campaign information. In some aspects, a claimed profile may allow a candidate to create a uniform candidate page for voters to donate and view the candidate's platform. In some aspects, the candidate list GUI 100 may comprise a voting lookup option 140, which may allow a voter to input information to determine voting details. For example, a voter may be able to input their address to determine where they can vote or which candidates are within their voting district.

The summary of candidates page may allow voters to see all organizational candidates in the races in their area. The page may identify all political races and each candidate in each race. Voters may select a candidate for additional information. In some embodiments, a candidate list GUI 100 may provide information regarding opponents within the elections. For example, if the managing group is a party, the candidate list GUI 100 may only include candidates affiliated with the party. Voters may be interested in knowing who the opponents are from other parties.

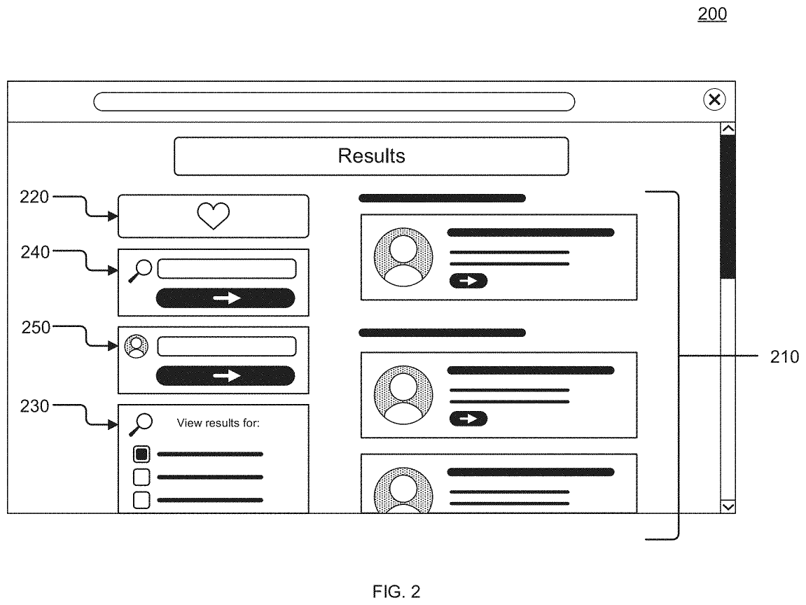

Referring now to FIG. 2, an exemplary candidate list graphical user interface (GUI) 200 is illustrated. In some implementations, the candidate list GUI 200 may comprise a sorted candidate list 210, which may include candidates eligible for an active election sorted by position or office. In some embodiments, the candidate list GUI 200 may comprise links to ballot lists 230 for active elections. In some embodiments, the candidate list GUI 200 may comprise a general support button 220, which may allow voters to directly contribute to a managing party. In some embodiments, the candidate list GUI 200 may comprise a search bar 250, which may allow voters to search by criteria such as candidate name, platform key words, positions, or other candidate information, as non-limiting examples.

In some aspects, the candidate list GUI 200 may comprise a voting lookup option 240, which may allow a voter to input information to determine voting details. As an illustrative example, a voter may be able to input their associations to see which elections may be open for voting. The voter may be a student at a university, part of the fraternity Alpha Beta Delta, and part of the chess club. By inputting that information, the voter may be able to view the board elections for the student counsel, the fraternity, and the chess club. By way of another example, a parent may search for the candidates running for the Harper Valley Parent-Teacher Association. In some embodiments, a voter may be able to log in, wherein the voter profile may include any associations and addresses.

In some embodiments, the platform may be accessed via a link on a managing group website. A “Meet The Candidate” link may direct voters to the summary of candidates page. In some aspects, managing groups may be able to replace their current “Donate Now” button, which may allow for flexibility as to associated processing fees.

In some implementations, the candidate list GUI 200 may allow for the selection of elections. In some embodiments, the search bars may allow for the capture of voter data. In some aspects, the candidate list GUI 200 may comprise customized URL based on the managing groups. In some embodiments, the candidate list GUI 200 may provide external links related to voting, such as a link to register to vote, to change addresses, or to request an absentee ballot, as non-limiting examples.

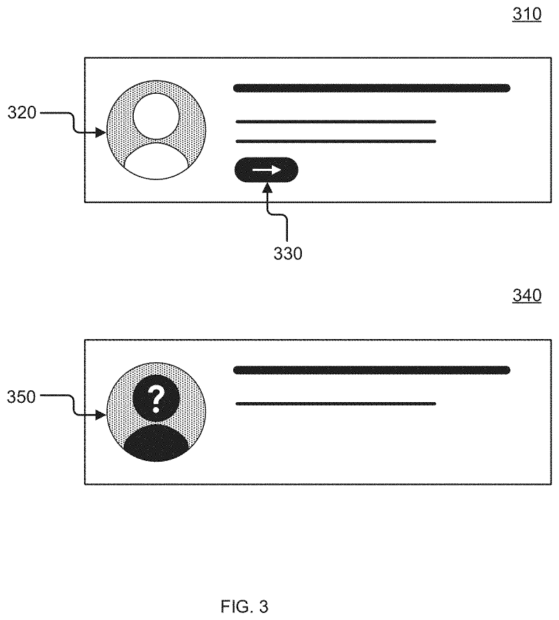

Referring now to FIG. 3, exemplary candidate listings 310, 340 are illustrated. In some embodiments, an unregistered candidate listing 340 may comprise a generic unregistered icon 350, such as a club crest or party symbol. In some aspects, a registered candidate listing 310 may comprise a registered candidate icon 320, which may be of the candidate's choosing, such as a personal photo. In some implementations, the registered candidate listing 310 may comprise a list to a candidate profile 330.

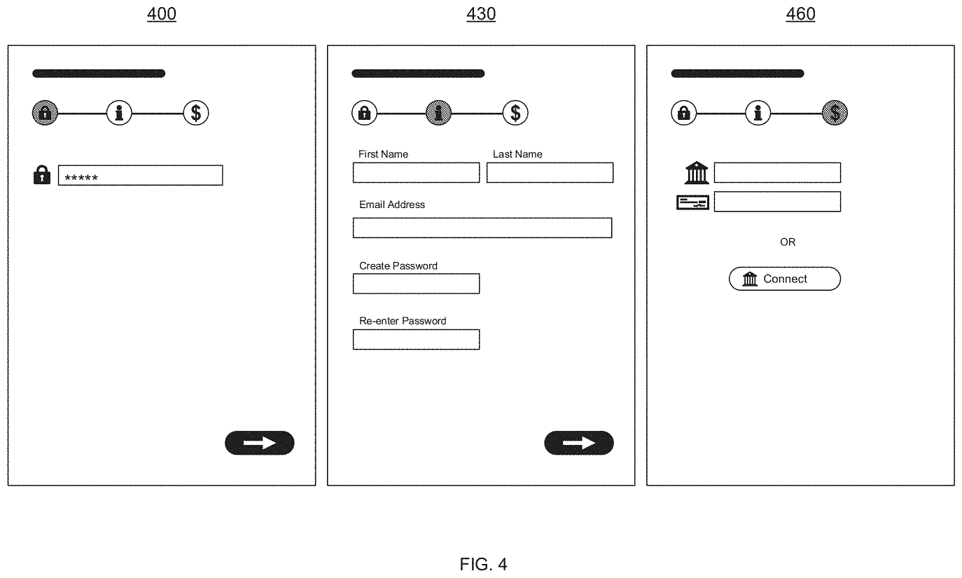

Referring now to FIG. 4, exemplary managing group interface panels 400, 430, 460 are illustrated. In some aspects, an access panel 400 may prompt a candidate to provide an access code that ensures that a verified individual claims their profile. In some embodiments, a registration panel 430 may prompt a candidate to provide base registration information to establish a profile. In some implementations, a donation panel 460 may prompt a candid ate to input banking information to be able to receive donations directly from the platform.

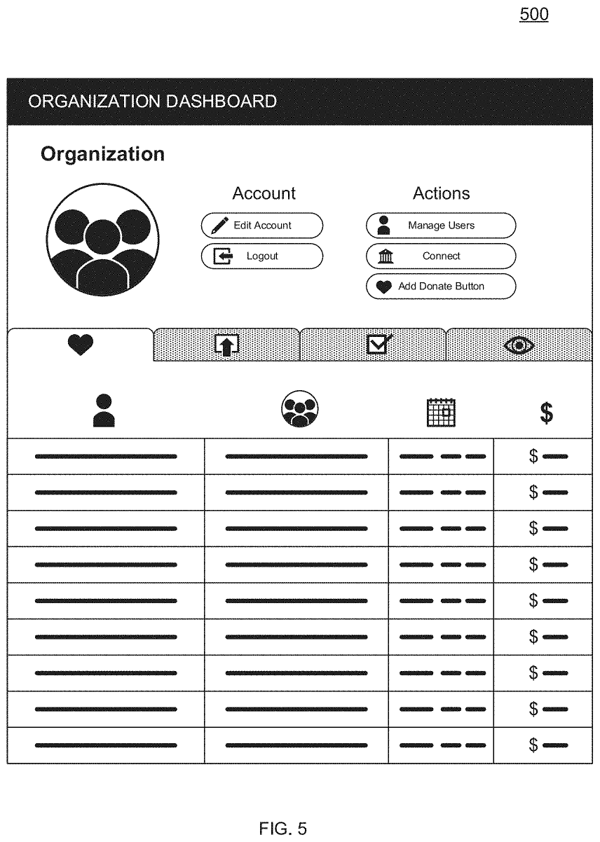

Referring now to FIG. 5, an exemplary managing group reporting graphical user interface (GUI) 500 is illustrated. In some embodiments, a managing group reporting GUI 500 may allow a user to view and download managing group and candidate donations. In some aspects, the donations may be sortable based on recipient, amount, date, voter data, or other relevant data. In some implementations, donation reports may be generated. In some embodiments, donations may be associated with voter data, which may include name, address, city, state, zip code, email, phone, occupation, and employer, as non-limiting examples.

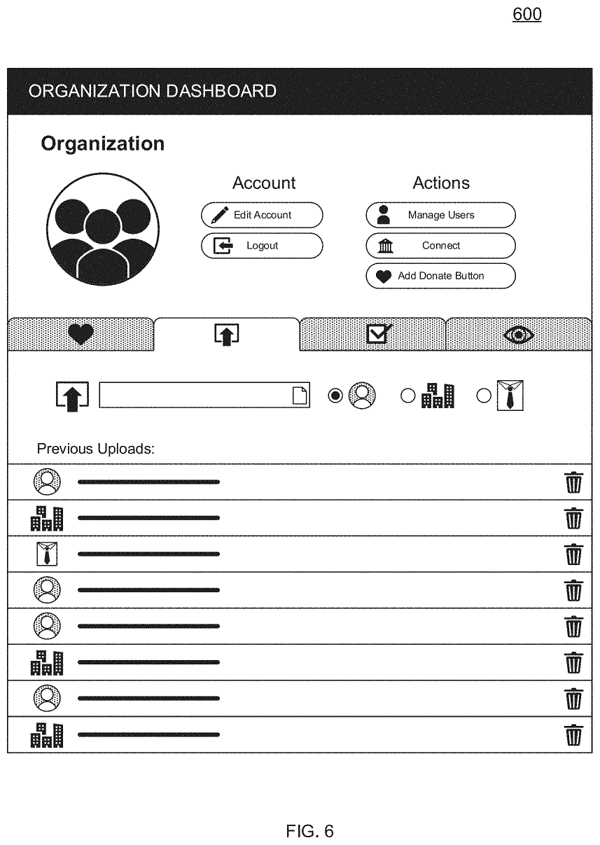

Referring now to FIG. 6, an exemplary managing group upload graphical user interface (GUI) 600 is illustrated. In some aspects, the managing group upload GUI 600 may allow for the management of voting files and candidate files. In some embodiments, the managing group upload GUI 600 may allow a managing group to add candidates to the platform through uploading files, which may be uploaded individually or in batches. In some aspects, the managing group upload GUI 600 may allow for the removal of candidates. In some implementations, the removal may be by position, individually, or by election dates. In some embodiments, the removal may be permanent, such as through deleting a file, or temporary, such as by toggling the visibility of a candidate.

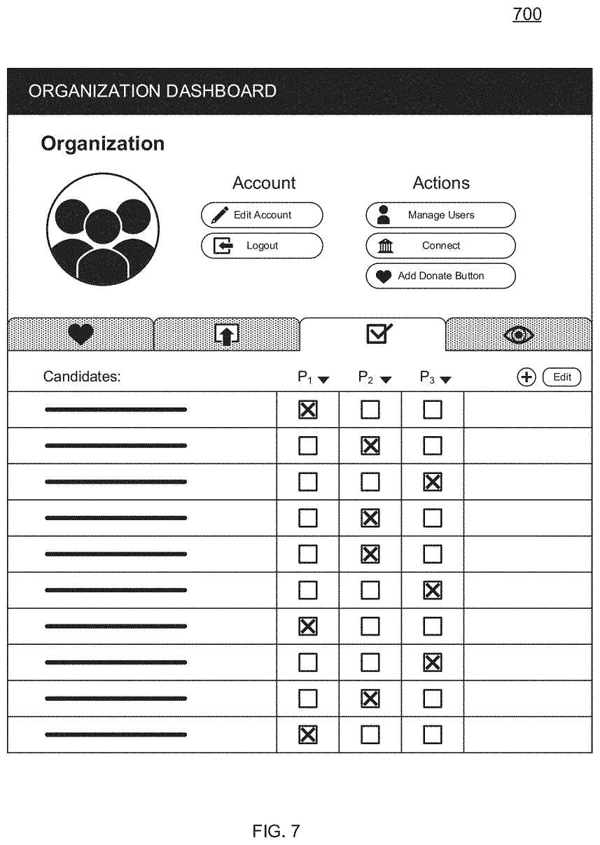

Referring now to FIG. 7, an exemplary managing group ballot graphical user interface (GUI) 700 is illustrated. In some embodiments, the managing group ballot GUI 700 may allow for the management of candidate listings associated with election ballots. In some aspects, a candidate may need to be removed from a ballot. For example, a candidate may drop out of an election, not receive enough votes in a primary, be disqualified from an election, or disassociate from the managing group.

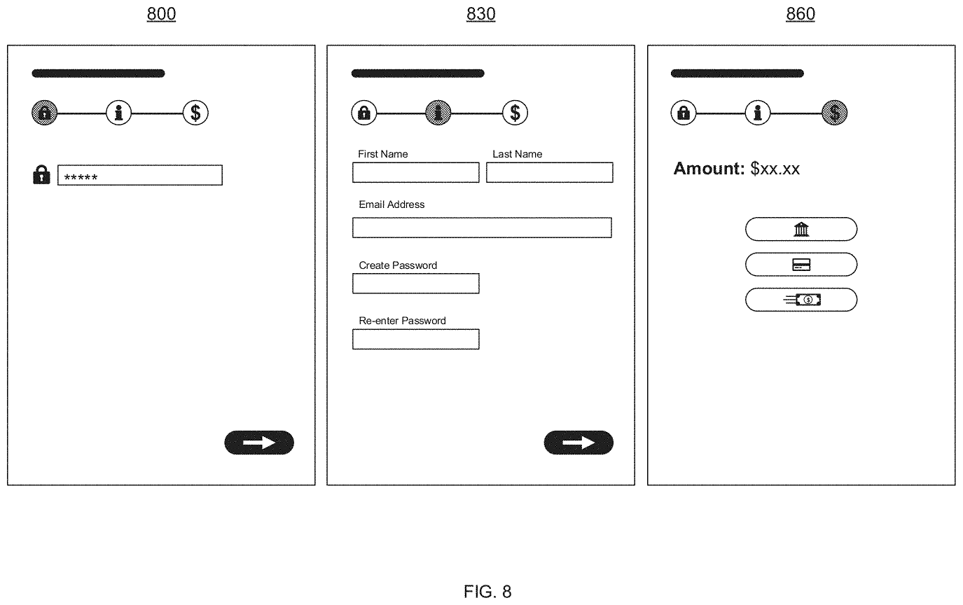

Referring now to FIG. 8, exemplary candidate interface panels 800, 830, 860 are illustrated. In some aspects, an access panel 800 may prompt a candidate to provide an access code that ensures that a verified individual claims their profile. In some embodiments, a registration panel 830 may prompt a candid ate to provide base registration information to establish a profile. In some implementations, a donation panel 860 may prompt a candid ate to input banking information to be able to receive donations directly from the donor via a securely connected payment platform.

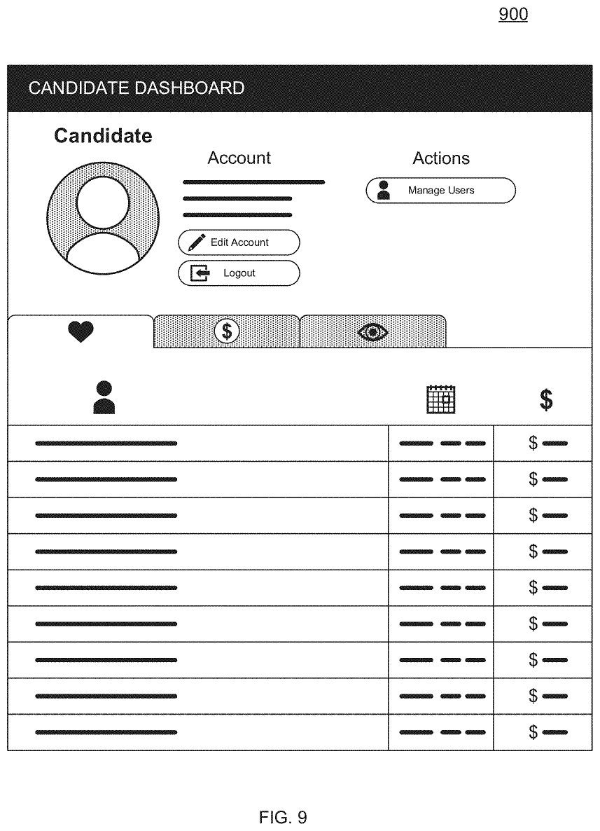

Referring now to FIG. 9, an exemplary candidate reporting graphical user interface (GUI) 900 is illustrated. In some embodiments, the candidate reporting GUI 900 may allow for management of donations, such as monitoring donations, accepting donations, rejecting donations, or downloading donation reports, as non-limiting examples. In some implementations, the candidate reporting GUI 900 may allow for the management of volunteer data.

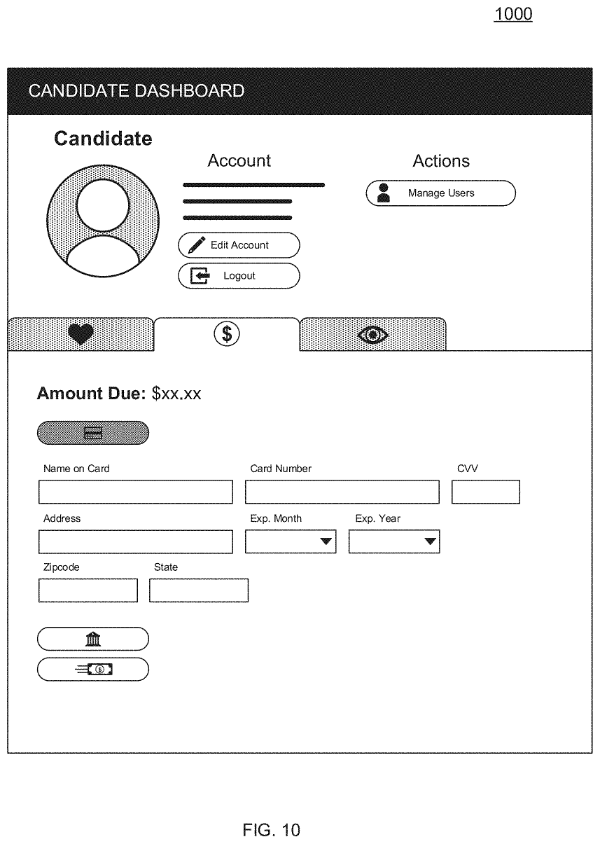

Referring now to FIG. 10, an exemplary candidate account graphical user interface (GUI) 1000 is illustrated. In some embodiments, the candidate account GUI 1000 may allow a candidate to manage their page, which may include text, photographs, videos, links, and design layouts, as non-limiting examples. In some aspects, the candidate account GUI 1000 may allow a candidate to view and manage payments that may be due, such as for use of the platform, membership dues, or election fees, as non-limiting examples.

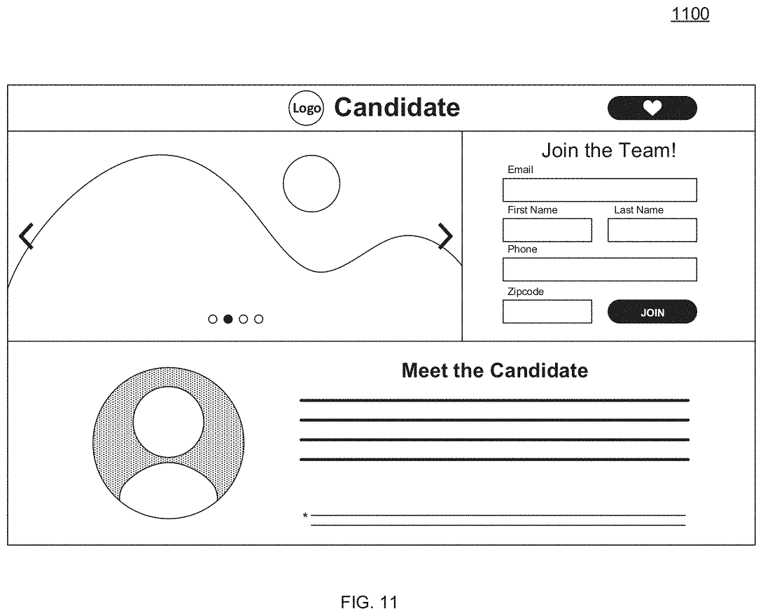

Referring now to FIG. 11, an exemplary candidate page 1100 is illustrated. In some aspects, a candidate page 1100 may be generated once a candidate claims their profile. In some embodiments, candidate may designate the email address for notification of a donation. In some aspects, the candidate page 1100 may comprise a candidate disclosure, which may include personal information, platform information, and campaign information, as non-limiting examples. In some embodiments, the candidate page 1100 may allow for legal donor authorization with data share. In some aspects, candidate may need donor data for reporting and inquiries, such as may be required in state or federal elections.

In some implementations, the platform may limit donations from a single voter based on regulations. In some embodiments, the limit may be based on a single donation. In some aspects, the limit may be linked to voter information, such as billing address, residence, social security number, and name, as non-limiting examples. In some implementations, the limit may be based on a temporal factor, such as per day or per month. In some embodiments, the ability to limit donations may be based on the amount and types of voter information collected during a donation.

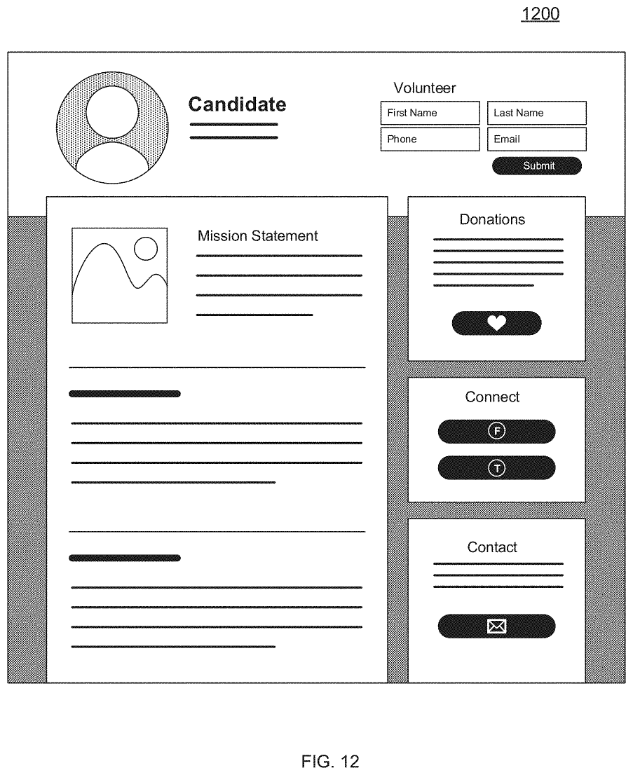

Referring now to FIG. 12, an exemplary candidate page 1200 is illustrated. The candidate's page may be hosted with a unique URL on the platform and may allow candidates to create a single page website to introduce themselves to voters and provide their background, qualifications, and “Where They Stand” messages, as a non-limiting list. The page also allows candidates the ability to upload photos and videos. A “Donate Now” functionality is included for each candidate. In some aspects, the candidate page 1200 may comprise a link to donate generally to a managing group, such as a party, club, university, and government body, as non-limiting examples.

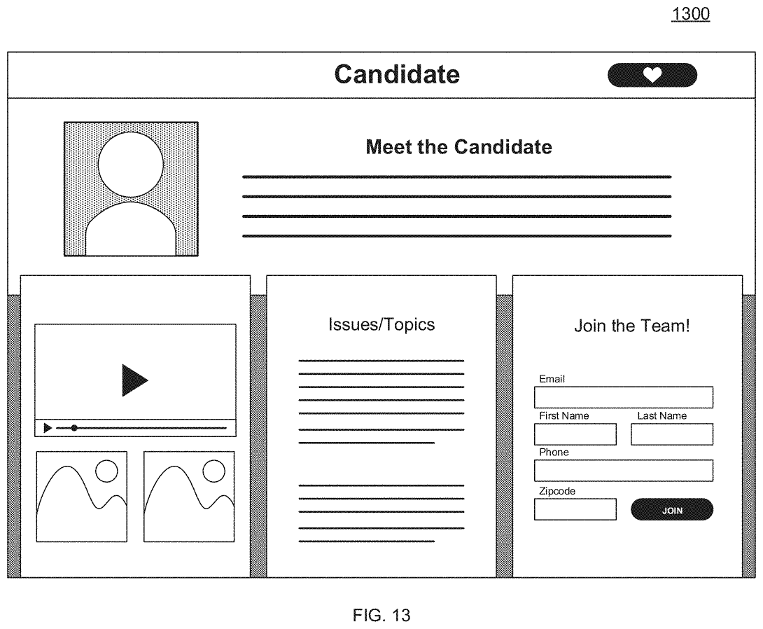

Referring now to FIG. 13, an exemplary candidate page 1300 is illustrated. In some aspects, the candidate page 1300 may allow voters to sign up to volunteer for a candidate's campaign. In some implementations, the candidate page 1300 may comprise a series of multimedia links that may allow voters to better know the candidate, wherein the multimedia may include video, photographs, audio, or other media. In some embodiments, the candidate page 1300 may comprise links to external sites, such as social media pages, affiliate pages, information related to the candidate's campaign platform. In some implementations, the candidate page 1300 may comprise a universal single-action access method. In some aspects, this access method may provide direct access to a specific utility within the candidate page 1300. For example, a QR code may be utilized from a side panel on the candidate page 1300 that may be scanned to reduce the required steps to make a donation to the candidate. The QR code may also be distributed on related printed materials for donation purposes or as a link to the candidate page 1300.

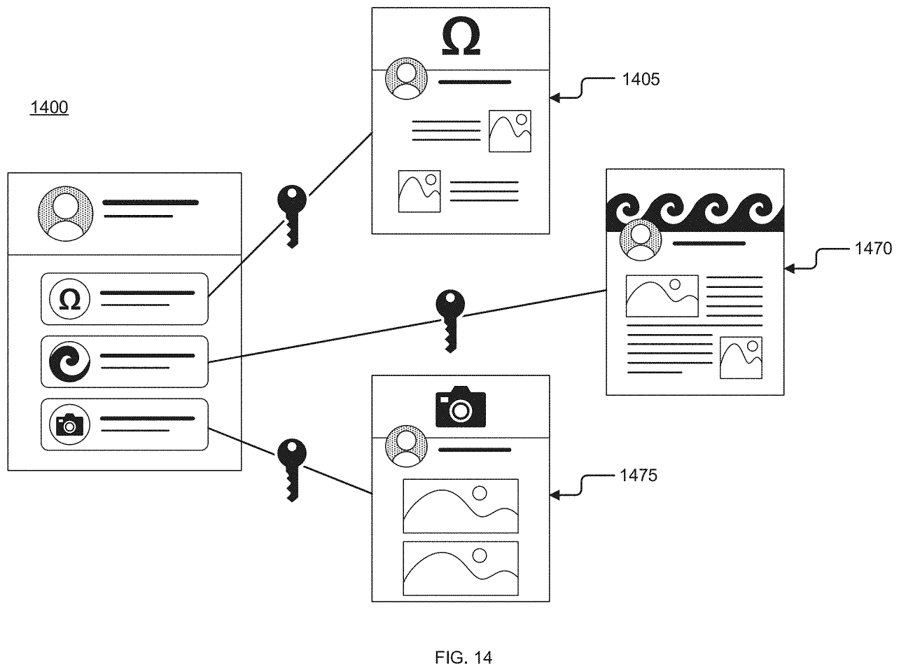

Referring now to FIG. 14, a plurality of exemplary candidate pages 1400, 1405, 1470, 1475 is illustrated. In some embodiments, the candidate data may comprise a plurality of elections. In some implementations, the candidate data may be managed by a plurality of management groups. In some aspects, a plurality of candidate pages may exchange candidate data to provide a centralized summary of related candidate pages 1405, 1470, 1475 to the public viewer. In some implementations, the candidate data may comprise information pertaining to one or more positions within a plurality of managing groups.

As an illustrative example, a candidate may be a member of a local photography club as well as a member of the community swim team. The candidate may utilize a candidate page for information pertaining to a nomination to an office in a local election. These candidate pages 1405, 1470, 1475 may be maintained by the respective organizations. Relevant information for public inquiry may be displayed in a condensed form on a centralized candidate page 1400.

In some embodiments, the candidate page display structure may restrict visibility to portions of the candidate page 1400 if the viewer is not of the managing group membership. In some implementations, the GUI may generate a plurality of candidate pages based on the candidate page display structure for each of the plurality of elections. In some aspects, the candidate page display structure may be influenced by the associated managing groups. In some implementations, the default candidate page 1400 may be populated via the plurality of candidate pages. In some aspects, the candidate page may comprise at least a portion of the candidate data from the referenced candidate pages 1405, 1470, 1475.

In some embodiments, the GUI may determine overlapping memberships by comparing the viewer management group data to the plurality of managing groups. This may allow for automatic conglomeration of related candidate data that is presented to the viewer. In some aspects, the associated candidate data resulting from overlapping memberships may provide a candidate page for the viewer. In some implementations, determining overlapping memberships may allow suggestions for additional groups of interest based upon the viewer's existing membership within a managing group.

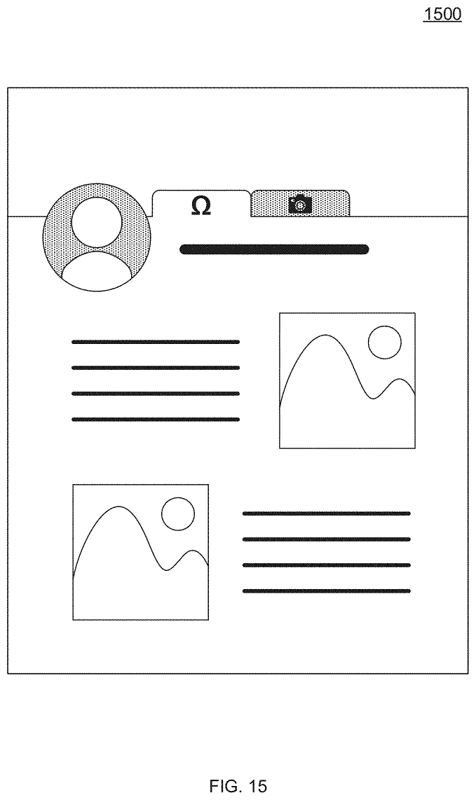

Referring now to FIG. 15, a plurality of exemplary candidate pages 1500 is illustrated. In some embodiments, the plurality of candidate pages 1500 may be nested as display tabulations. In some implementations, the candidate page 1500 may be populated via the plurality of candidate pages. In some aspects, the candidate page display structure may be influenced by the associated managing groups. In some embodiments, the candidate page display structure may restrict visibility to portions of the candidate page 1500 if the viewer is not of the managing group membership. In some implementations, the GUI may generate a plurality of candidate pages based on the candidate page display structure for each of the plurality of elections.

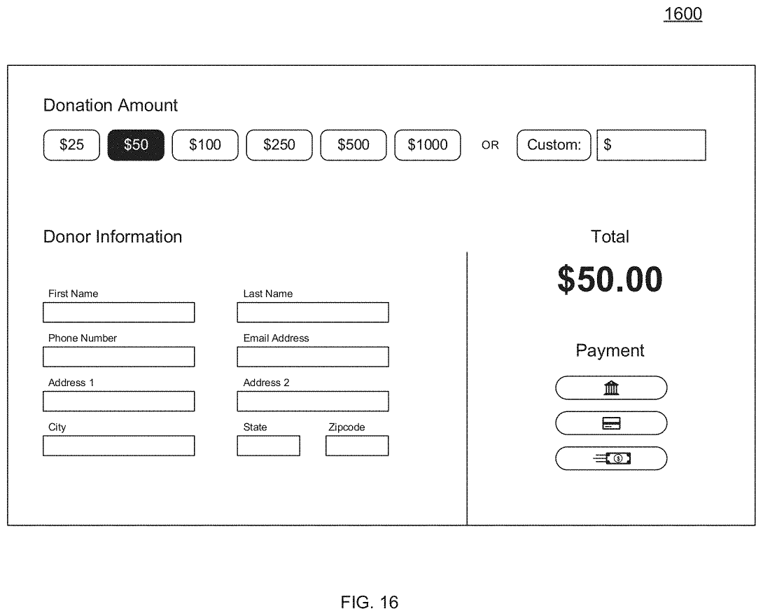

Referring now to FIG. 16, an exemplary voter donation graphical user interface (GUI) 1600 is illustrated. In some aspects, a voter donation GUI 1600 may prompt the input of standard billing information, which may be required to process a payment. In some embodiments, one or both the candidate and the managing group may monitor and track donations, which may require collection of additional data. For example, some state and federal elections regulate donations and require collecting employment data from donors. As another example, a university may only permit other students to donate to internal groups. Accordingly, the voter donation GUI 1600 may prompt input of employer data or student identification data.

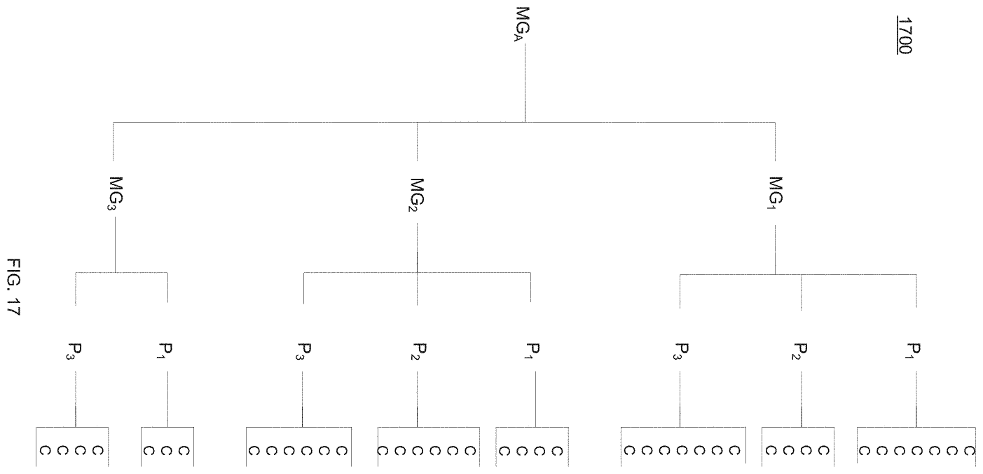

Referring now to FIG. 17, an exemplary candidate management platform organization structure 1700 is illustrated. In some aspects, a managing group may comprise a governing body to which candidates may be elected. In some embodiments, a managing group may comprise a political party that may want to provide access to information about candidates to voters. In some aspects, one type of managing group may have managing authority over a predefined set of parameters and a second type of managing group may have managing authority over a separate set of parameters.

As an illustrative example, an election may comprise a state primary election. One type of managing group may comprise government bodies, such as municipals, state, or city, as non-limiting examples. Another type of managing group may comprise the parties. Each party may manage a portion of the candidate management platform, such as those candidates that align with each party. The parties may be able to organize and manage the interface for voters who may align with the party. At the government body level, the managing groups may be able to verify ballots and periodically ensure the donations conform to regulations.

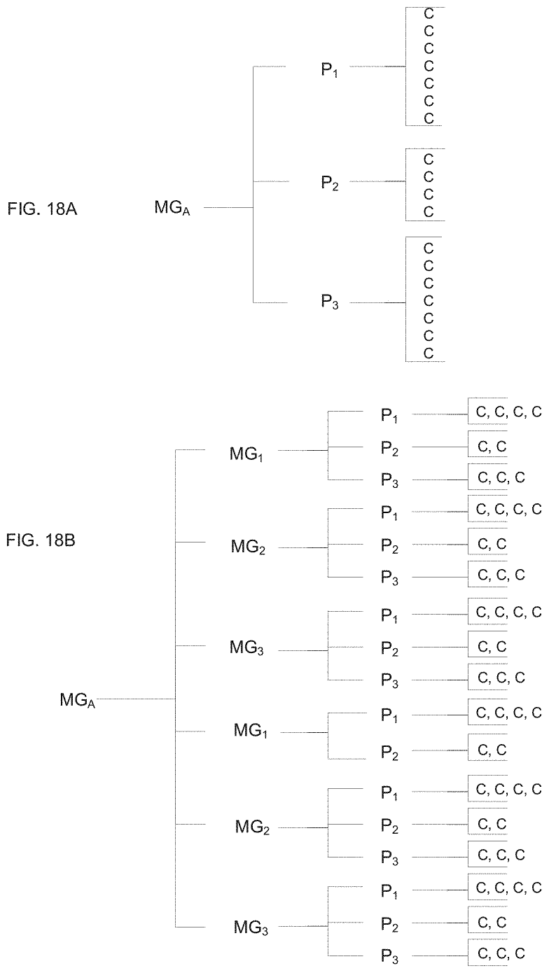

Referring now to FIGS. 18A-18B, an exemplary candidate management platform organization structures 1800, 1850 are illustrated. In some aspects, the organization structure may differbetween elections, wherein managing group A may directly manage the candidate listing for one election and manage other managing groups for other elections. As an illustrative example, a university may directly manage a candidate list for an internal election for university positions. The same university may indirectly oversee the elections within university clubs and Greek houses.

In some embodiments, the managing groups may claim overlapping candidates, such as where a candidate may be running in multiple elections or where a candidate's campaign platform may fit with multiple parties. It may be the responsibility of the candidate to verify their affiliations. In some implementations, a candidate may be able to claim separate profiles for each position. For example, a candidate may be running for treasurer of student counsel, president of the robotics team, and a vice president of her sorority, wherein the candidate may want to run on different platforms for each election. She may be able to claim each candidate profile separately. In some embodiments, she may be able to merge them into one profile.

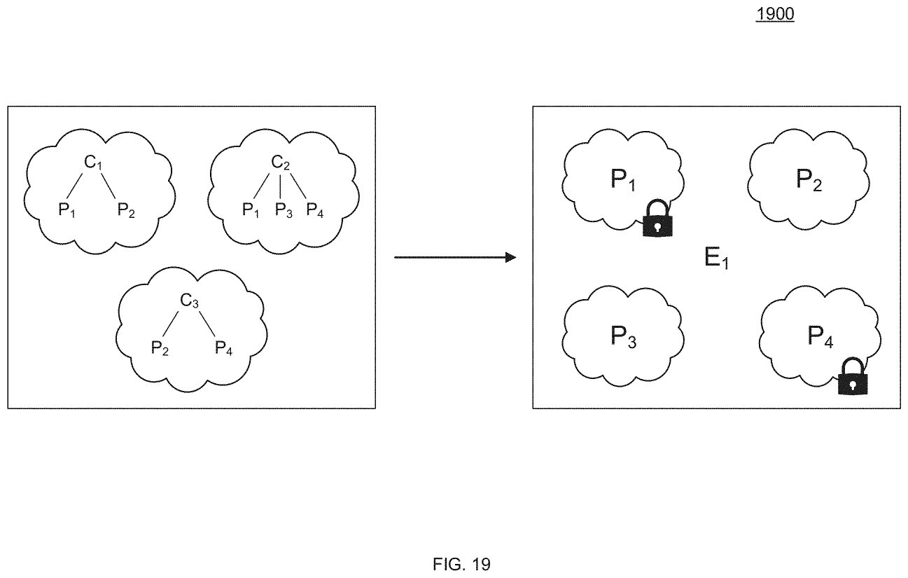

Referring now to FIG. 19, an exemplary candidate management platform organization structure 1900 is illustrated. In some embodiments, the organization structure 1900 may comprise a plurality of candidates. In some implementations, candidates may participate in multiple elections simultaneously. These elections may comprise different positions. In some aspects, the organization structure may associate each candidate with their positions within each election. In some embodiments, the database structure of the organization structure may comprise relational databases that connect a plurality of positions via a candidate.

In some implementations, a viewer may have access to view multiple positions for a candidate on a candidate page. In some aspects, the viewer may select a position of interest and view details of a position from the candidate page. In some embodiments, the positions of a candidate may provide limited detail to a view. In some implementations, viewing a position on a candidate page may require membership with the associated managing group.

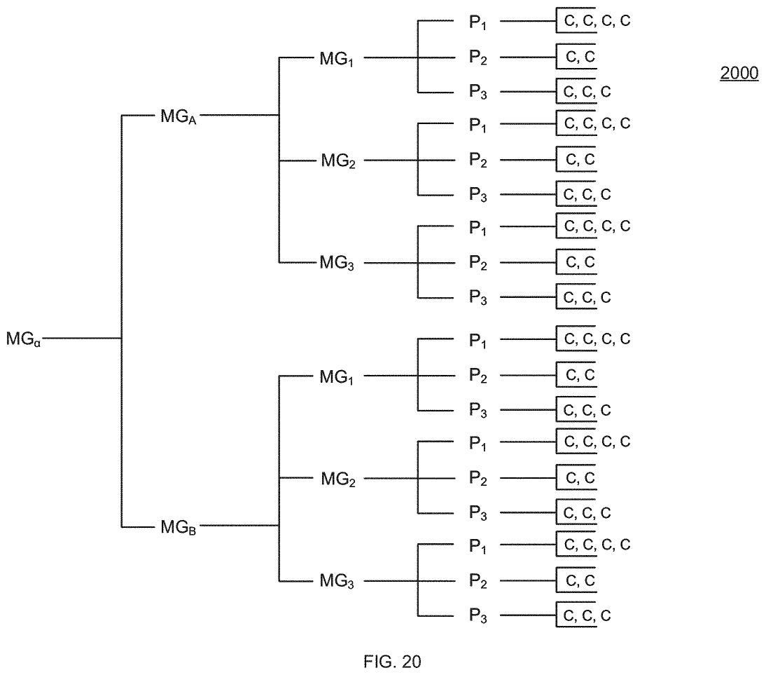

Referring now to FIG. 20, an exemplary candidate management platform organization structure 2000 is illustrated. In some embodiments, the organization structure 2000 may comprise a plurality of nested organization structures. In some implementations, the organization structure may comprise non-person elections such as a vote to conduct a specific type of event, as a non-limiting example. p As an illustrative example, a college may operate as the managing group for a plurality of departments. Within the film department, there may be a cinematography club, a film club, and a stunt club. The film department may operate as a managing group for the clubs within the film department. The college may also operate as the managing group for an athletic group. Within the athletic department, a soccer club may collect votes on an upcoming opening social and a tennis club may hold an election for club leadership. The athletic department may facilitate these elections as a managing group in addition to the college functioning as a managing group.

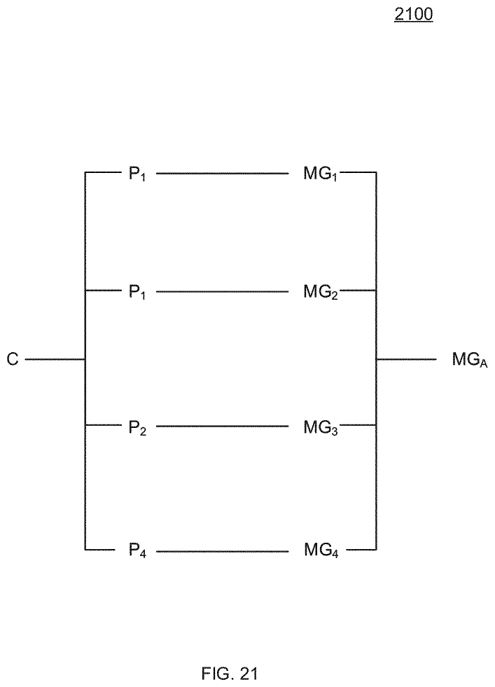

Referring now to FIG. 21, an exemplary candidate management platform organization structure 2100 is illustrated. In some embodiments, the organization structure 2100 may generate a candidate page. In some implementations, the candidate page may comprise candidate data. In some aspects, the candidate data may comprise a name, one or more elections, membership with an affiliated managing group, as a non-limiting list.

In some embodiments, the managing group membership may indicate an association of the candidate with the managing group, one or more positions, position data, as a non-limiting list. In some aspects, the candidate page may display position data for a plurality of positions within the same managing group. As an example, a candidate may seek support in becoming a lead researcher within a research firm as well as being placed on a disease-specific sub-committee within the research group. In some implementations, the organization structure 2100 may comprise a plurality of nested organization structures. In some aspects, the nested organization structures may operate as managing groups over their designated organization within the greater organization structure 2100.

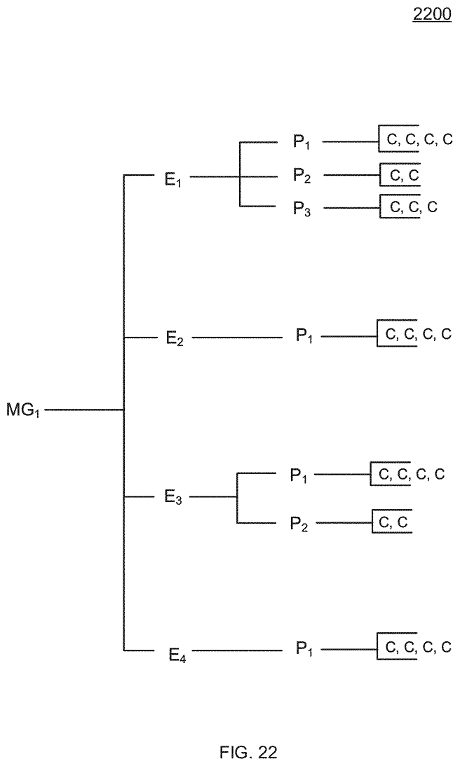

Referring now to FIG. 22, an exemplary candidate management platform organization structure is illustrated. In some aspects, the organization structure 2200 may comprise a plurality of elections. In some embodiments, the organization structure 2200 may comprise a plurality of nested organization structures. In some implementations, the nested organization structures may not be identical. In some implementations, the organization structure may comprise non-person elections such as a vote to conduct a specific type of event, as a non-limiting example.

As an illustrative example, the movie club may simultaneously host elections for what manner of activities an upcoming social gathering should consist of, which movies to play in 3 hosted theaters, as well as the members of the leadership board of the club. There may be two options for the upcoming social gathering, ten film options for the theaters, and 3 potential board members for the club.

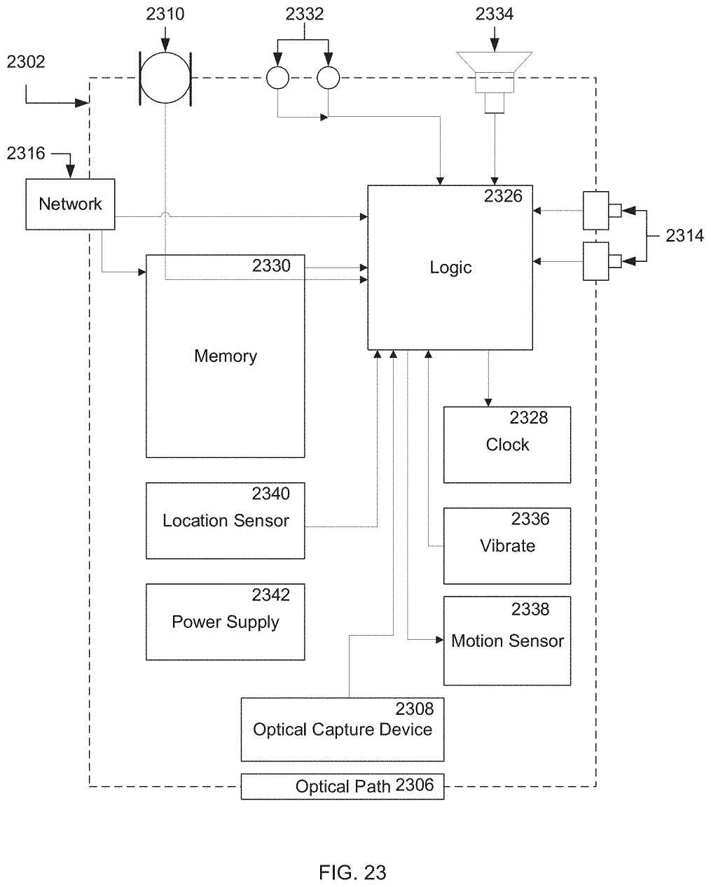

Referring now to FIG. 23, a block diagram of an exemplary apparatus that may be used to implement aspects of the present disclosure is illustrated, wherein the exemplary apparatus may compise a mobile device 2302. The mobile device 2302 may comprise an optical capture device 2308, which may capture an image and convert it to machine-compatible data, and an optical path 2306, typically a lens, an aperture, or an image conduit to convey the image from the rendered document to the optical capture device 2308. The optical capture device 2308 may incorporate a Charge-Coupled Device (CCD), a Complementary Metal Oxide Semiconductor (CMOS) imaging device, or an optical sensor of another type.

In some embodiments, the mobile device 2302 may comprise a microphone 2310, wherein the microphone 2310 and associated circuitry may convert the sound of the environment, including spoken words, into machine-compatible signals. Input facilities 2314 may exist in the form of buttons, scroll-wheels, or other tactile sensors such as touch-pads. In some embodiments, input facilities 2314 may include a touchscreen display. Visual feedback 2342 to the user may occur through a visual display, touchscreen display, or indicator lights. Audible feedback 2334 may be transmitted through a loudspeaker or other audio transducer. Tactile feedback may be provided through a vibration module 2336.

In some aspects, the mobile device 2302 may comprise a motion sensor 2338, wherein the motion sensor 2338 and associated circuity may convert the motion of the mobile device 2302 into machine-compatible signals. For example, the motion sensor 2338 may comprise an accelerometer, which may be used to sense measurable physical acceleration, orientation, vibration, and other movements. In some embodiments, the motion sensor 2338 may comprise a gyroscope or other device to sense different motions.

In some implementations, the mobile device 2302 may comprise a location sensor 2340, wherein the location sensor 2340 and associated circuitry may be used to determine the location of the device. The location sensor 2340 may detect Global Position System (GPS) radio signals from satellites or may also use assisted GPS where the mobile device may use a cellular network to decrease the time necessary to determine location. In some embodiments, the location sensor 2340 may use radio waves to determine the distance from known radio sources such as cellular towers to determine the location of the mobile device 2302. In some embodiments these radio signals may be used in addition to and/or in conjunction with GPS.

In some aspects, the mobile device 2302 may comprise a logic module 2326, which may place the components of the mobile device 2302 into electrical and logical communication. The electrical and logical communication may allow the components to interact. Accordingly, in some embodiments, the received signals from the components may be processed into different formats and/or interpretations to allow for the logical communication. The logic module 2326 may be operable to read and write data and program instructions stored in associated storage 2330, such as RAM, ROM, flash, or other suitable memory. In some aspects, the logic module 2326 may read a time signal from the clock unit 2328. In some embodiments, the mobile device 2302 may comprise an on-board power supply 2332. In some embodiments, the mobile device 2302 may be powered from a tethered connection to another device, such as a Universal Serial Bus (USB) connection.

In some implementations, the mobile device 2302 may comprise a network interface 2316, which may allow the mobile device 2302 to communicate and/or receive data to a network and/or an associated computing device. The network interface 2316 may provide two-way data communication. For example, the network interface 2316 may operate according to an internet protocol. As another example, the network interface 2316 may comprise a local area network (LAN) card, which may allow a data communication connection to a compatible LAN. As another example, the network interface 2316 may comprise a cellular antenna and associated circuitry, which may allow the mobile device to communicate over standard wireless data communication networks. In some implementations, the network interface 2316 may comprise a Universal Serial us (USB) to supply power or transmit data. In some embodiments, other wireless links known to those skilled in the art may also be implemented.

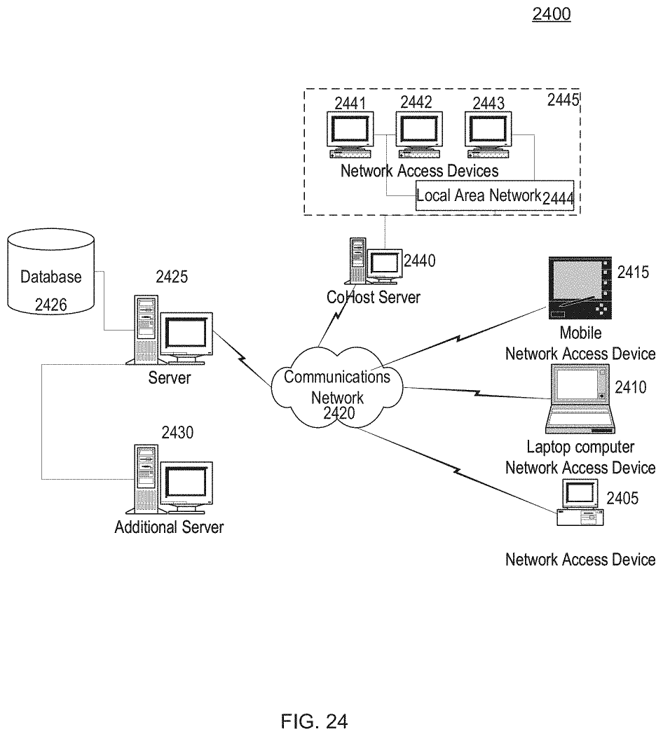

Referring now to FIG. 24, an exemplary processing and interface system 2400 is illustrated. In some aspects, access devices 2415, 2410, 2405, such as a paired portable device 2415 or laptop computer 2410 may be able to communicate with an external server 2425 though a communications network 2420. The external server 2425 may be in logical communication with a database 2426, which may comprise data related to identification information and associated profile information. In some embodiments, the server 2425 may be in logical communication with an additional server 2430, which may comprise supplemental processing capabilities.

In some aspects, the server 2425 and access devices 2405, 2410, 2415 may be able to communicate with a cohost server 2440 through a communications network 2420. The cohost server 2440 may be in logical communication with an internal network 2445 comprising network access devices 2441, 2442, 2443 and a local area network 2444. For example, the cohost server 2440 may comprise a payment service, such as PayPal or a social network, such as Facebook or a dating website.

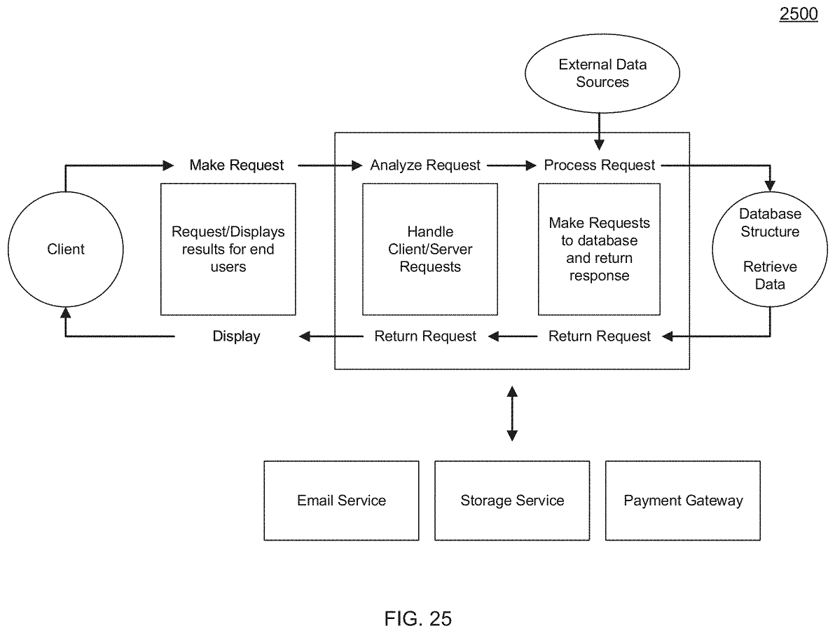

Referring now to FIG. 25, an exemplary process flowchart for a candidate management platform 2500 is illustrated. In some aspects, the system may comprise a platform, such as Angular 4, that may make it easy to build applications with the web. The platform may combine declarative templates, dependency injection, end to end tooling, and integrated best practices to solve development challenges. In some embodiments, the system may comprise an asynchronous event driven runtime. In some implementations, the system may comprise a web framework that may provide a robust set of features for and mobile applications.

In some embodiments, the system may comprise a relational database management system, which may use structured query language. In some aspects, the system may comprise a cloud-based email delivery platform that may deliver transactional and marketing emails. In some embodiments, the system may comprise a storage service that may be used to store and retrieve data from the web. In some implementations, the storage service may give a developer access to highly scalable, reliable, fast, inexpensive data storage infrastructure. In some aspects, the system may comprise an online payment module, which may accept donations for one or more the candidates and the managing groups.

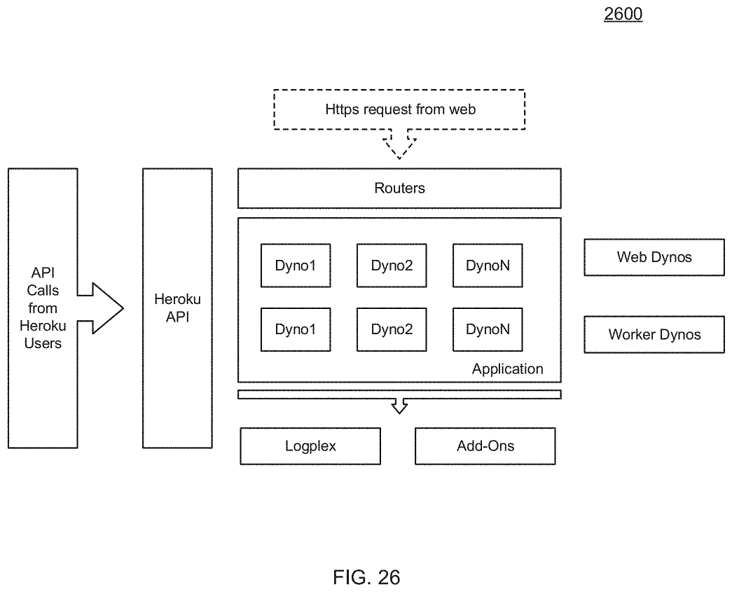

Referring now to FIG. 26, an exemplary block diagram for a candidate management platform 2600 is illustrated. In some embodiments, the platform may comprise one or more router, which may ensure that application receives the requests from users on the web. In some aspects, the platform may comprise on or more customizable bots, which may comprise isolated, virtualized containers that may be designed to execute code based on a user-specified command. In some embodiments, the platform may comprise a distributed syslog log router, which may be able to merge and redistribute multiple incoming streams of syslog logs to individual subscribers. In some implementations, the platform may interface with external service vendors that may provide a service and make it available to the platform, such as through add-ons application programming interfaces (API).

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A method for generating a candidate page comprising:
receiving candidate data for a first candidate, wherein the candidate data comprises:
a name,
a first election,
a first managing group membership, wherein the first managing group membership indicates an association of the first candidate with a first managing group,
a first position,
and first position data;
identifying the first election within the managing group;
identifying a first candidate page display structure associated with the first election based on the first managing group;
generating a first candidate page based on the first candidate page display structure; and
populating the first candidate page with the name and the first position data.

2. The method of claim 1, accessible to members of the first management group.

3. The method of claim 1, further comprising identifying the first managing group membership for the first candidate.

4. The method of claim 1, wherein the first candidate page is at least partially customizable by the candidate.

5. The method of claim 1, further comprising accessing an external third party database, wherein at least a portion of the first position data is received from the external third party database.

6. The method of claim 1, further comprising:
receiving a first access request through a server for a first viewer to view the first candidate page;
confirming a first viewer membership to the first managing group; and
providing the first candidate page to the first viewer if the first viewer membership exists.

7. The method of claim 6, wherein the first candidate page is at least partially customizable by the first viewer.

8. The method of claim 1, wherein the candidate data further comprises:
a second election;
a second managing group membership, wherein the second managing group membership indicates an association of the first candidate with a second managing group;
a second position; and
and second position data.

9. The method of claim 8, further comprising:
identifying the second election within the second managing group;
identifying a second candidate page display structure associated with the first election based on the second managing group;
generating a second candidate page based on the second candidate page display structure; and
populating the second candidate page with the name and the second position data.

10. The method of claim 1, wherein the candidate data further comprises:
a second managing group membership, wherein the second managing group membership indicates an association of the first candidate with a second managing group.

11. The method of claim 10, further comprising:
identifying a second candidate page display structure associated with the first election based on the second managing group;
generating a second candidate page based on the second candidate page display structure; and
populating the second candidate page with the name and the first position data.

12. The method of claim 11, wherein the second candidate page is a default page display for the first candidate.

13. The method of claim 12, further comprising:
receiving a first access request through a server for a first viewer to view the first candidate page;
confirming a first viewer membership to the first managing group; and
providing the second candidate page to the first viewer if the first viewer membership does not exist.

14. A method for generating a candidate page comprising:
receiving candidate data for a first candidate, wherein the candidate data comprises:
a name,
a plurality of elections,
a plurality of managing group memberships for a plurality of managing groups, wherein each of the plurality of managing group memberships indicate an association with at least one of the plurality of managing groups,
a plurality of positions,
and a plurality of sets of position data, wherein each set is associated with at least one of the plurality of positions;
associating each of the plurality of elections with at least a portion of the plurality of managing groups;
identifying a candidate page display structure for each of the plurality of elections based on associated managing groups;
generating a plurality of candidate pages based on the candidate page display structure for each of the plurality of elections based on associated managing groups; and
populating the plurality of candidate pages with at least a portion of the candidate data.

15. The method of claim 14, further comprising:
receiving a first access request through a server for a first viewer to view at least one of the plurality of candidate pages;
receiving viewer management group data;
comparing the viewer management group data to the plurality of managing groups, wherein comparing determines overlapping memberships; and
providing at least one candidate page to the first viewer based on overlapping memberships.

16. The method of claim 14, further comprising accessing an external third party database, wherein at least a portion of the plurality of sets of position data is received from the external third party database.

17. A method for managing elections, the method comprising:
identifying a plurality of elections;
receiving a plurality of candidates, wherein each of the plurality of candidates are running for a position within at least one of the plurality of elections;
generating a plurality of candidate page display structures, wherein each of the plurality of candidate page display structures are associated with each of the plurality of election; and
providing the plurality of candidate page display structures, wherein providing allows for population and display of a plurality of candidate pages.

18. The method of claim 17, further comprising managing at least a portion of the plurality of candidate pages.

19. The method of claim 18, wherein managing comprises monitoring donations submitted through candidate pages.

20. The mehod of claim 19, wherein managing further comprises limiting donations for each of the plurality of candidates.
